(19) United States
(12) Patent Application Publication
(10) Pub. No.: US 2008/0053025 A1
(43) Pub. Date: Mar. 6, 2008

(54) CLIP

(76) Inventors: Rich Howe, Pleasant View, UT (US); Neil Watson, Layton, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/733,140

(22) Filed: Apr. 9, 2007

Related U.S. Application Data
(60) Provisional application No. 60/790,364, filed on Apr. 7, 2006.

(51) Int. Cl. F16B 5/06

(52) U.S. Cl. 52/544

(57) ABSTRACT

A clip may be connected to a first piece of siding and a second piece of siding, and the clip may be used to interconnect the pieces of siding. The clip may include a first attachment portion and a second attachment portion. The first attachment portion may include one or more extensions that may engage the first piece. The extensions may include one or more serrated portions, which may include one or more inwardly extending portions and/or outwardly extending portions that are sized and configured to engage the first piece. The second attachment portion may include one or more structures that may engage a second piece of trim or siding. If desired, these one or more structures may allow the clip to hang from the second piece of trim.

### CROSS-REFERENCE TO RELATED APPLICATIONS

This application claims priority to and the benefit of U.S. provisional patent application Ser. No. 60/790,364, filed on Apr. 7, 2006 and entitled CLIP, which is incorporated by reference in its entirety.

### BACKGROUND OF THE INVENTION

1. Field of the Invention

The present invention generally relates to connectors and, in particular, to clips that may be used to install siding.

2. Description of Related Art

Many types of enclosures are used for storing various items such as tools, machines, lawn care equipment, recreational equipment, athletic equipment, supplies and the like. Conventional storage enclosures often include walls, doors, floors, roofs, windows and other assorted features.

Sheds are well known type of storage enclosures. Sheds are typically relatively small structures that may be either freestanding or attached to another structure, and sheds are often used for storage and/or shelter. Sheds may also be larger structures that allow larger pieces of equipment or larger quantities of materials to be stored. Many conventional sheds include four walls, but sheds may also be open at the sides or ends.

Known enclosures may include siding and the siding may be used to construct a wall or other portion of the enclosure. In particular, the siding may form a facing or outer portion of the enclosure and the siding may help create a weatherproof enclosure. Conventional siding is often composed of pieces that are separately attached to the enclosure, such as shingles or boards. In addition, conventional siding is often used for surfacing the outside walls of a frame building or enclosure.

Known enclosures may also include one or more pieces of trim, which may be used to decorate the enclosure. For example, trim may be used around the windows or doors of the enclosure.

Conventional siding and trim is often attached to known enclosure by using metal fasteners such as screws or nails. Unfortunately, pieces of siding and trim may be rather difficult and time consuming to install. In addition, when the metal fasteners are exposed to the elements, such as rain and snow, the fasteners to rust. This rust can damage the fasteners and discolor the siding or trim. The metal fasteners can also damage the enclosure, siding or trim if the fasteners are not carefully installed. Further, if may be very tricky to properly connect the siding or trim to the enclosure. Disadvantageously, if the siding or trim is not properly connected to the enclosure, then the siding or trim may easily become loosened or detached from the enclosure.

### BRIEF SUMMARY OF EMBODIMENTS OF THE INVENTION

A need therefore exists for a clip that eliminates or diminishes the disadvantages and problems described above.

One aspect is a clip that may be used to install building materials or components such as siding or trim. For example, the clip may be used to connect siding or trim to an enclosure. In addition, the clip may be sized and configured to be connected to one or more components, such as a first piece of siding and a second piece of siding. The clip may also be used to interconnect two or more components.

Another aspect is a clip that may be used to attach or connect materials or components to an enclosure such as a shed. In particular, the clip may be used to attached siding or trim to a shed. It will be appreciated that the clip may also be used to attach or connect other suitable materials or structures to a shed. It will also be appreciated that the clip may be used in connection with other types of enclosures.

Yet another aspect is a clip that may include a first portion and a second portion. The first portion preferably includes one or more extensions that may engage a first piece of siding or trim. The extensions may include serrations, which extend inwardly and/or outwardly, and the serrations may be sized and configured to engage the first piece of siding or trim. In particular, the serrations may be sized and configured to bite into and engage the siding or trim to securely connect the clip to the siding or trim. The first portion may also be connected to the siding or trim by a snap, friction or interference fit, if desired. The second portion preferably includes one or more engaging structures, such as tabs, hooks or the like, that engage a second piece of siding or trim. These engaging structures may allow the clip to be securely connected to the second piece of siding or trim. The engaging structures may also the clip to hang from the second piece of trim. Thus, the clip may allow one or more pieces of siding or trim to be interconnected. It will be appreciated, however, that the clip may be connected to the siding and/or trim in other suitable arrangements and configurations. It will also be appreciated that the clip may be connected to the siding or trim by fasteners, adhesives and the like. It will further be appreciated that a clip may have other suitable shapes, sizes, configurations and arrangements depending, for example, upon the shape, size, configuration and/or arrangement of the siding or trim.

Still yet another aspect is a clip that may be connected to one or more components, such as pieces of siding or trim for an enclosure. For example, the siding or trim may include one or more receiving portions, such as folds, that are sized and configured to receive and/or retain one or more portions of the clip. In greater detail, the first piece of siding or trim preferably includes a first fold that is sized and configured to receive and/or retain a first portion of the clip and a second fold that is sized and configured to receive and/or retain a second portion of the clip. Preferably, the second piece of siding or trim includes a fold that is sized and configured to receive and/or retain at least a portion of an engaging structure, such as a tab, but it could be sized and configured to receive and/or retain any desired portion of the clip. Advantageously, the clip and/or receiving portions may include serrations, which may help securely connect the clip and the siding or trim.

A further aspect is a clip that may have a generally planar configuration. For example, the clip may be constructed from a sheet of material. In particular, the clip may be stamped from a sheet of material, such as metal. The clip may include an engaging structure such as a tab and the tab may be moved between a first position in which the tab is generally aligned with the body of the clip and a second or extended position in which the tab extends outwardly and away from the body of the clip. When the tab is in the extended position, the clip may be quickly and easily connected to another object such as siding or trim. In particular, if the siding or trim includes receiving portions, then the outwardly extending tab may be quickly and easily inserted into the receiving portions.

A still further aspect is a clip that may be used to connect siding or trim to an enclosure. When the clip connects the siding or trim to the enclosure, the clip is preferably at least substantially disposed within the siding or trim. Advantageously, this may help protect the clip from damage. For example, if the clip is disposed within or covered by the siding or trim, that may help prevent the clip from being damaged from the elements. In addition, this may create an enclosure with a more appealing visual appearance because the clip may be hidden from view.

Another aspect is a clip that may be constructed from a relatively strong and durable material such as metal. In particular, the clip may be constructed from steel but it will be appreciated that the clip may also be constructed from other materials with suitable characteristics. In addition, the clip may be quickly and easily manufactured. For example, the clip may be quickly and easily cut, formed or stamped from a sheet of metal or steel. Advantageously, this may allow the clip to be quickly and inexpensively manufactured. It will be appreciated, however, that the clip may be constructed using other suitable processes and methods.

Still another aspect is a clip that may be sized and configured to be quickly and effectively connected to various components, such as trim or siding. In addition, the clip sized and configured to be quickly and effectively disconnected from the siding or desired. The clip may also be quickly and effectively connected and disconnected, d, to various structures and enclosures, such as sheds.

These and other aspects, features and advantages of the present invention will more fully apparent from the following detailed description of preferred ents and appended claims.

### BRIEF DESCRIPTION OF THE DRAWINGS

The appended drawings contain figures of preferred embodiments to further illustrate and clarify the above and other aspects, advantages and features of the present invention. It will be appreciated that these drawings depict only preferred embodiments of the invention and are not intended to limit its scope. The invention will be described and explained with additional specificity and detail through the use of the accompanying drawings in which:

FIG. 1 is a front view of an exemplary clip;

FIG. 2 is a perspective view of the clip shown in FIG. 1;

FIG. 3 is a perspective view of a portion of an enclosure, illustrating the clip shown in FIG. 1 and exemplary siding or trim;

FIG. 4 is an enlarged perspective view of the portion of the enclosure shown in FIG. 3, illustrating the clip connected to a first piece of siding or trim;

FIG. 5 is an enlarged perspective view of a portion of the enclosure shown in FIG. 3, illustrating the clip being connected to a second piece of siding or trim;

FIG. 6 is a perspective view of the portion of the enclosure shown in FIG. 3, illustrating the clip in broken lines and connected to the first piece of siding or trim and the second piece of siding or trim; and

FIG. 7 is a front view of the portion of the enclosure shown in FIG. 3.

### DETAILED DESCRIPTION OF THE PREFERRED EMBODIMENTS

The present invention is generally directed towards a clip that may be connected to one or more components. In particular, the clip may be sized and configured to be connected to components, such as siding or trim, which may be used in connection with an enclosure such as a shed. Advantageously, the clip may be used to quickly and easily attach and/or install the siding or trim. The principles of the present invention, however, are not limited to installing siding or trim to a shed. It will be understood that, in light of the present disclosure, the clip disclosed herein can be successfully used for attaching and/or installing various components and structures. It will also be understood that the clip may be used in connection with other types of buildings and structures. Therefore, while the following description and accompanying figures discuss and illustrate the clip being used in connection with installing siding or trim on a shed, it will be appreciated that the clip may be used in connection with other types of structures and may have a variety of suitable uses.

Additionally, to assist in the description of the clip, words such as top, bottom, front, rear, right and left may be used to describe the accompanying figures, which are not necessarily drawn to scale. It will be appreciated, however, that the clip can be located in a variety of desired positions—including various angles, sideways and even upside down. A detailed description of the clip now follows.

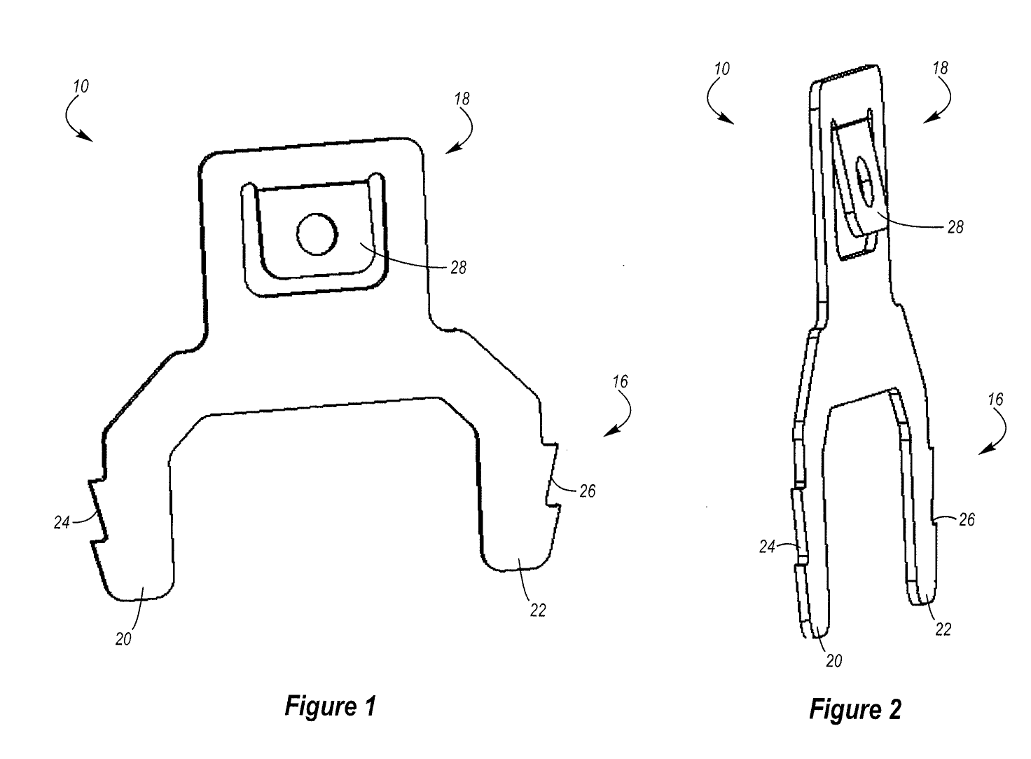

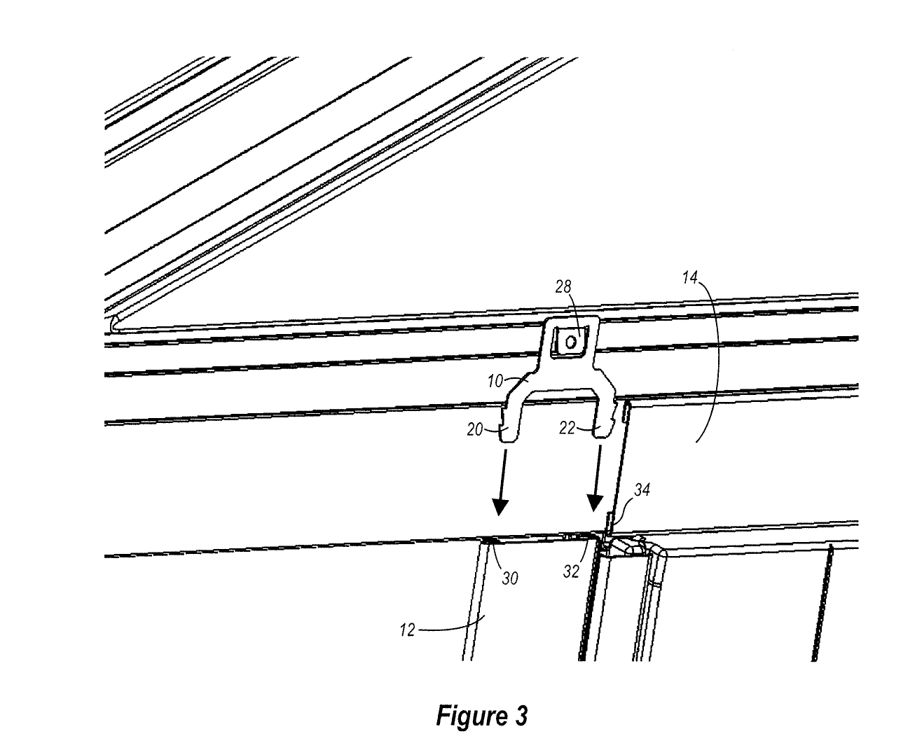

As shown in FIGS. 1 and 2, the clip 10 may include a first attachment portion 16 and a second attachment portion 18. The first attachment portion 16 preferably includes a first extension or arm 20 and a second extension or arm 22. The extensions 20, 22 may include serrations 24, 26, which may include inwardly and/or outwardly extending portions. The second attachment portion 18 preferably includes an engaging structure 28, such as a tab or hook.

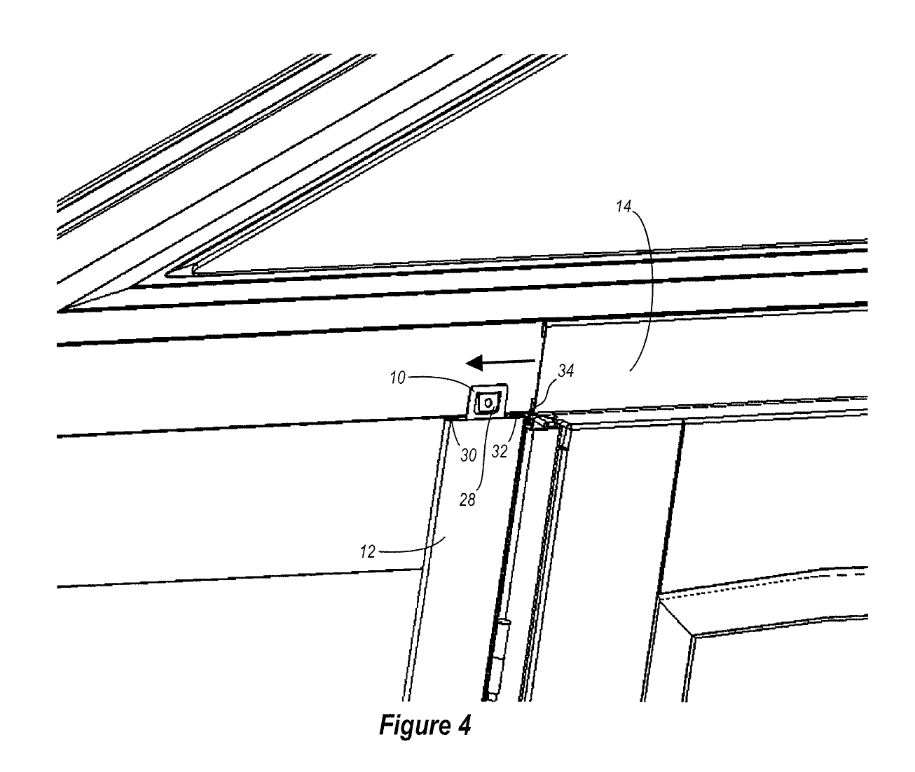

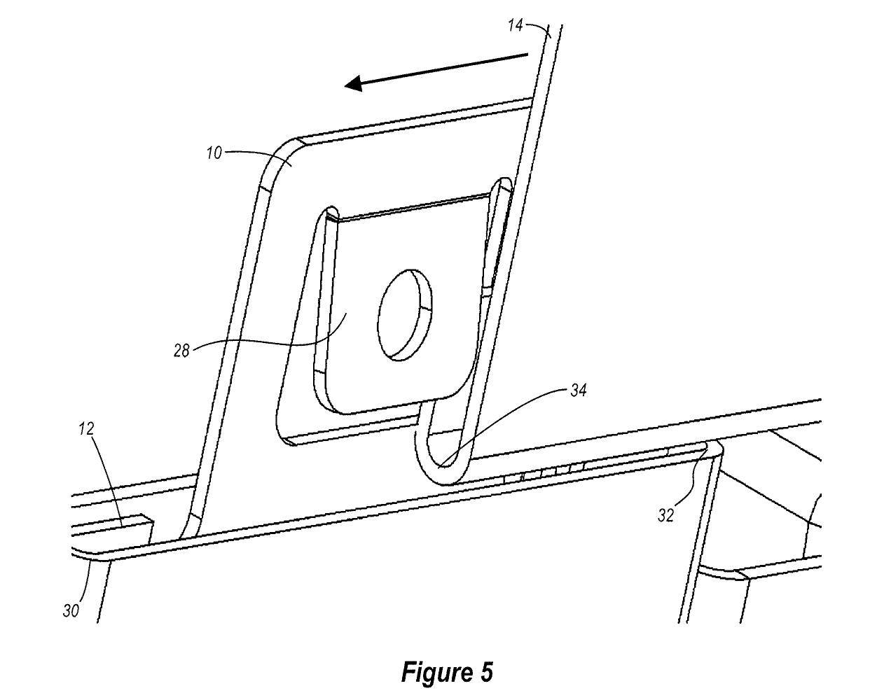

As shown in FIGS. 3-7, the clip 10 may be used to interconnect components and/or attach components to an enclosure such as a shed. In particular, the clip 10 may be used to install siding on a shed. However, as discussed above, the clip 10 may be used to install other components, such as trim, and the clip may be used in connection with other types of structures, buildings and the like.

In greater detail, the clip 10 may be sized and configured to be connected to a first piece of siding 12 and a second piece of siding 14. Advantageously, the clip 10 may be used to interconnect the first piece of siding 12 and the second piece of siding 14. For example, the serrations 24, 26 on the extensions 20, 22 may be sized and configured to engage a portion of the first piece of siding 12. In particular, the serrations 24, 26 may bite into and engage a portion of the first piece of siding 12. The engaging structure 28 may be sized and configured to engage a portion of the second piece of siding 14. Specifically, the engaging structure 28 may be disposed within a receiving portion to connect the clip 10 to the second piece of siding 14. It will be appreciated, however, that the clip 10 may be connected to the siding 12, 14 in other suitable fashions or manners, such as by a snap, friction and/or interference fit. In addition, it will be appreciated that the clip 10 may be connected to the siding 12, 14 by fasteners, adhesives and the like.

Significantly, the clip 10 may allow the pieces of siding 12, 14 to be connected at an angle. In particular, the first piece of siding 12 may be generally vertically disposed and the second piece of siding 14 may be generally horizontally disposed. In order to interconnect the first and second pieces of siding 12, 14, the clip 10 may be connected to the first piece of siding 12 and then the clip may be connected to the second piece of siding 14. Specifically, the clip 10 may hang from the second piece of siding 14. For example, the engaging structure 28 may allow the clip 10 to hang from the second piece of siding 14. Accordingly, the clip 10 may be connected to the first and second pieces of siding 12, 14.

It will be appreciated that the clip 10 may include any suitable number of attachment portions and extensions depending, for example, upon the intended number of pieces of siding to be attached to the clip. It will also be appreciated that the clip 10 may be connected to the pieces of siding 12, 14 in any suitable fashion. It will further be appreciated that the clip 10 may have other suitable sizes, shapes, configurations and arrangements depending, for example, upon the size, shape, configuration and/or arrangement of the siding.

In order to facilitate connection of the clip 10 to the siding 12, 14, the siding preferably includes one or more receiving portions. The receiving portions are preferably sized and configured to receive and/or retain one or more portions of the clip 10. Advantageously, the receiving portions may be formed in the edges of the siding 12, 14. For example, the receiving portions may be formed by the folded edges of the siding 12, 14. It will be appreciated that the receiving portions may be formed in any desired portions of the siding 12, 14 and the receiving portions may be integrally formed with the siding or the receiving portions could be connected to the siding.

In particular, the first piece of siding 12 preferably includes a first fold 30 that is sized and configured to receive and/or retain at least a portion of the first extension 20 of the clip 10. In addition, the first piece of trim 12 preferably includes a second fold 32 that is sized and configured to receive and/or retain at least a portion of the second extension 22 of the clip 10. The extensions 20, 22 are preferably sized and configured to be connected to the first and second folds 30, 32 of the first piece of siding 12. For example, the serrations 24, 26 of the extensions 20, 22 may be sized and configured to engage and bite into the first and second folds 30, 32 respectively.

The second piece of siding 14 also preferably includes one or more receiving portions that are sized and configured to receive and/or retain at least a portion of the clip 10. For example, the second piece of siding 14 may include a fold 34, which is preferably similar to the folds 30, 32 of the first piece of siding 12. Advantageously, this may allow the pieces of siding 12, 14 to be interchangeably connected and used in connection with the clip 10. This may simplify the connection of the siding 12, 14 to the clip 10 by allowing the pieces to be interchangeably connected. It will be appreciated, however, that the receiving portions of the second piece of siding 14 and the receiving portions of the first piece of siding 12 do not have to be similar or allow the siding to be interchangeably connected to the clip 10.

In greater detail, the fold 34 of the second piece of siding 14 is preferably sized and configured to receive and/or retain at least a portion of the tab 28 of the clip 10. In particular, when the tab 28 is inserted into the fold 34, that may allow the clip 10 and the second piece of siding 14 to be interconnected.

Significantly, the clip 10 may be quickly and effectively connected to the siding 12, 14. For example, the extensions 20, 22 may be quickly inserted into the folds 30, 32 to connect the clip 10 to the first piece of siding 12, and the tab 28 may be quickly inserted into the fold 34 to connect the clip to the second piece of siding 14. In addition, the clip 10 may be quickly and effectively disconnected from the folds 30, 32, 34, if desired. It will be appreciated that the clip 10, siding 12, 14 and/or receiving portions of the siding may have other suitable shapes, sizes, configurations and arrangements depending, for example, upon the intended use, function, positioning and the like of the siding.

As best seen in FIGS. 1 and 2, the clip 10 may have a generally planar configuration. For example, the clip 10 may include a generally planar body and the body may include at least a portion of the first portion 16 and/or second portion 18. In particular, the first portion 16 of the clip may have a generally planar configuration and a portion of the second portion 18 may have a generally planar configuration. Preferably, the first and second portions 16, 18 of the clip 10 have a generally planar configuration other than the engaging portion 28, which may be movable between one position in which the engaging portion is generally aligned with the body of the clip and another position in which the engaging portion extends outwardly relative to the body of the clip. This may allow the clip 10 to be constructed from a planar sheet of material, such as steel, and the engaging portion 28 may be moved into the outwardly extending position when it is desired to be connected to another structure such as the second piece of siding 14.

The clip 10 is preferably constructed from a relatively strong and sturdy material such as metal. In particular, the clip 10 is preferably constructed from steel to create a long-lasting and durable clip. In addition, the clip 10 may be quickly and easily manufactured by cutting, forming or stamping the clip from a sheet of material. It will be appreciated, however, that the clip 10 may be constructed from other materials with suitable characteristics and it may be formed by other processes and methods.

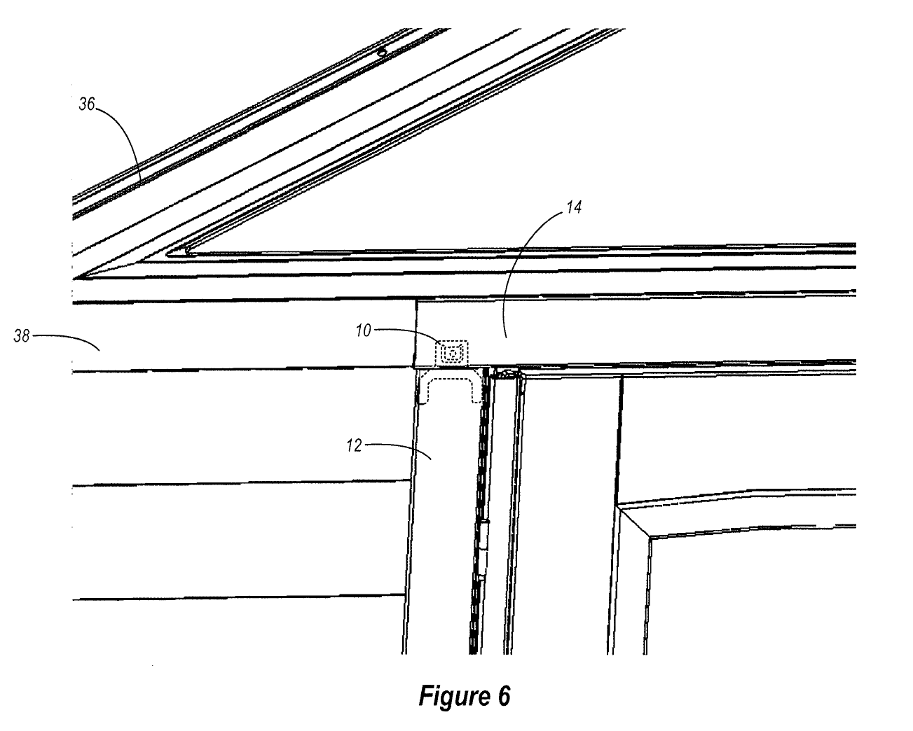

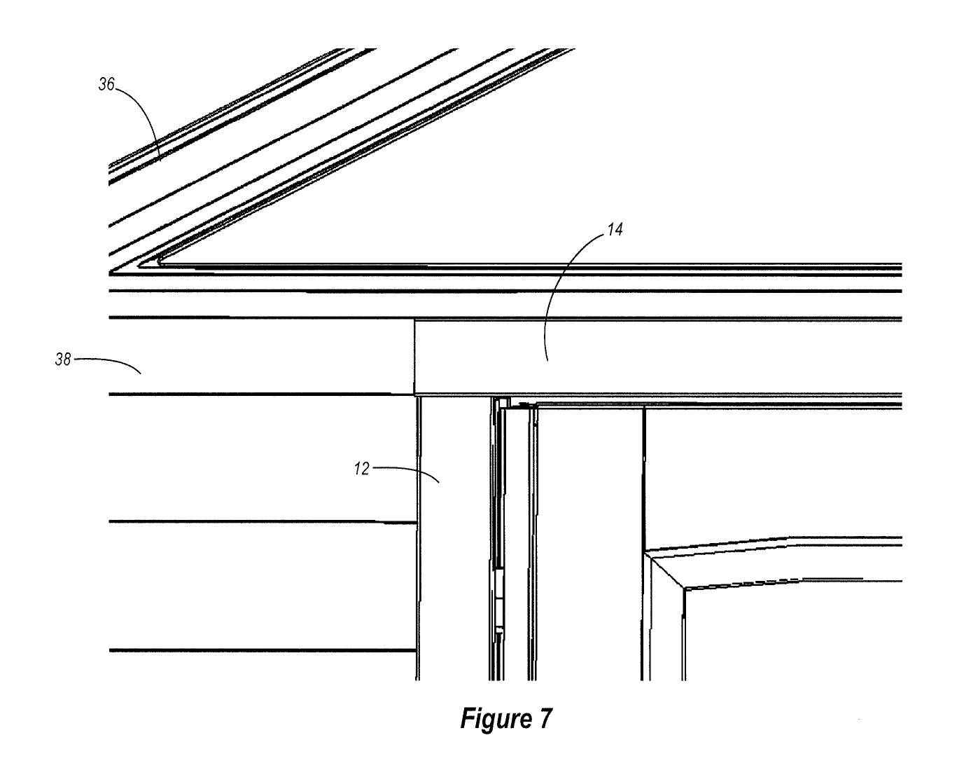

As shown in FIGS. 6-7, the pieces of siding 12, 14 preferably cover at least a substantial portion of the clip 10. Advantageously, this may help protect the clip 10 from exposure to rain, other wet conditions and/or other adverse conditions that may damage the clip. In addition, this may create a more aesthetically pleasing appearance because the clip 10 may not be visible. Moreover, the clip 10 may help maintain the pieces of siding 12, 14 in the desired positions and orientations, which may help provide a cleaner and more appealing visual appearance.

In addition, the clip 10 may help create and maintain a relatively tight joint or connection between the pieces of siding 12, 14. In particular, the siding 12, 14 may be constructed from materials that may expand or contract when subjected to hot or cold weather conditions, and the clip 10 may help create and maintain a relatively tight connection between the pieces of trim as they expand or contract.

The clip 10 may also help facilitate attachment of the siding 12, 14 to an enclosure or structure, such as a shed 36. The clip 10 may also allow the siding 12, 14 to be quickly and easily installed and/or moved into the desired locations. For example, as shown in FIGS. 6 and 7, the first and second pieces of siding 12, 14 may be connected by the clip 10. Advantageously, the clip 10 may help position and retain the siding 12, 14 in the desired positions relative to an outer wall 38 of the shed 36.

The clip 10 may be used in connection with different types of sheds 36 and sheds constructed from various materials. For example, at least a portion of the shed 36, such as the walls, door, floor and roof, may be constructed from blow-molded plastic and may include a hollow interior portion formed during the blow-molding process. It will be appreciated, however, that the shed 36 may be constructed from other suitable materials using other suitable processes.

Advantageously, the clip 10 may be used to connect pieces of siding 12, 14 without requiring any holes be drilled or formed in the shed 36. This may help maintain the structural integrity of the shed 36 and prevent water from entering the shed. In addition, the clip 10 may allow pieces of siding 12, 14 to be quickly and easily positioned in various desired locations relative to the shed 36 without damaging or modifying the shed.

Significantly, the clip 10 may be used in connection with sheds 36 that have a wide range of shapes, sizes, configurations and arrangements. Additionally, the clip 10 may be used in connection with sheds 36 that have a variety of features and aspects, such as in U.S. patent application Ser. No. 11/091,606, filed Mar. 28, 2005, entitled MODULAR ENCLOSURE WITH LIVING HINGES; U.S. patent application Ser. No. 11/091,620, filed Mar. 28, 2005, entitled DOOR ASSEMBLY FOR A MODULAR ENCLOSURE; U.S. patent application Ser. No. 11/091,811, filed Mar. 28, 2005, entitled ROOF SYSTEM FOR A MODULAR ENCLOSURE; U.S. patent application Ser. No. 11/091,813, filed Mar. 28, 2005, entitled SYSTEM AND METHOD FOR CONSTRUCTING A MODULAR ENCLOSURE; U.S. patent application Ser. No. 11/091,837, filed Mar. 28, 2005, entitled MODULAR ENCLOSURE WITH OFFSET PANELS; U.S. patent application Ser. No. 11/091,849, filed Mar. 28, 2005, entitled PACKAGING SYSTEM FOR A MODULAR ENCLOSURE; and U.S. patent application Ser. No. 11/091,861, filed Mar. 28, 2005, entitled FLOOR FOR A MODULAR ENCLOSURE; each of which are incorporated by reference it its entirety.

As mentioned above, the clip 10 may be used to interconnect the first and second pieces of siding 12, 14. In some uses, for example, the clip 10 may be first connected to the first piece of siding 12 and then to the second piece of siding 14. In other uses, the clip 10 may be first connected to the second piece of siding 14 and then to the first piece of siding 12. In still other uses, the clip 10 may be connected to the first and second pieces of siding 12, 14 at the same time. Any or all of these uses may allow the first piece of siding 12 to hang from the second piece of siding 14. The first piece of siding 12, however, need not hang from the second piece of siding 14. Thus, the clip 10 may be connected to the first and second pieces of siding 12, 14 in any particular order or manner to interconnect the pieces of siding 12, 14 and, if desired, also allow the first piece of siding 12 to hang from the second piece of siding 14.

Although this invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A clip for interconnecting a first piece of a siding and a second piece of siding, the clip comprising:
a first attachment portion comprising:
a first extension including a serrated portion that is sized and configured to engage a first portion of a first piece of siding; and
a second extension including a serrated portion that is sized and configured to engage a second portion of the first piece of siding, the second extension being spaced apart from the first extension; and
a second attachment portion that is sized and configured to be connected to a second piece of siding.

2. The clip as in claim 1, wherein the second attachment portion is sized and configured to allow the first piece of siding to hang from the second piece of siding.

3. The clip as in claim 1, wherein the second attachment portion includes a tab that is sized and configured to allow the first piece of siding to hang from the second piece of siding.

4. The clip as in claim 1, wherein the first and second attachment portions are formed from a sheet of material.

5. The clip as in claim 1, wherein the first and second attachment portions are formed from sheet metal.

6. The clip as in claim 1, wherein at least a portion of the first and second attachment portions have a generally planar configuration.

7. A siding system comprising:
a first piece of siding;
a second piece of siding; and
a clip comprising:
a first attachment portion comprising:
a first extension sized and configured to engage a first portion of the first piece of siding; and
a second extension sized and configured to engage a second portion of the first piece of siding, the second portion of the first piece of siding being spaced apart from the first portion of the first piece of siding; and
a second attachment portion sized and configured to be connected to the second piece of siding.

8. The siding system as in claim 7, wherein the second attachment portion is sized and configured to allow the first piece of siding to hang from the second piece of siding.

9. The siding system as in claim 7, wherein the second attachment portion includes a tab sized and configured to allow the first piece of siding to hang from the second piece of siding.

10. The siding system as in claim 7, wherein the first and second attachment portions are formed from a sheet of material.

11. The siding system as in claim 7, wherein the first and second attachment portions are formed from sheet metal.

12. The siding system as in claim 7, wherein the first and second attachment portions are form at least part of a generally planar configuration.

13. The siding system as in claim 7, wherein the first piece of siding includes a first receiving portion and a second receiving portion, the first receiving portion being sized and configured to receive at least a portion of the first extension, the second receiving portion being sized and configured to receive at least a portion of the second extension.

14. The siding system as in claim 7, wherein the first piece of siding includes a first fold and a second fold, the first fold being sized and configured to receive at least a portion of the first extension, the second fold being sized and configured to receive at least a portion of the second extension.

15. A method for interconnecting pieces of siding, the method comprising:
inserting one or more portions of a clip into one or more receiving portions of a first piece of siding, the one or more portions of the clip engaging the one or more receiving portions of the first piece of siding; and
inserting at least a portion of the clip into at least one receiving portion of a second piece of siding to hang the first piece of siding from the second piece of siding.

16. The method as in claim 15, wherein the one or more portions of the clip bite into the one or more receiving portions of the first piece of siding.

17. The method as in claim 15, wherein the one or more portions of the clip engage the one or more receiving portions of the first piece of siding using a snap fit.

18. The method as in claim 15, wherein the one or more portions of the clip engage the one or more receiving portions of the first piece of siding using a friction fit.

19. The method as in claim 15, wherein the one or more portions of the clip engage the one or more receiving portions of the first piece of siding using an interference fit.
